(19) United States
(12) Patent Application Publication
(10) Pub. No.: US 2025/0157150 A1
(43) Pub. Date: May 15, 2025

(54) IMAGE GENERATION METHOD, APPARATUS, ELECTRONIC DEVICE, AND STORAGE MEDIUM

(71) Applicant: Lemon Inc., Grand Cayman (KY)

(72) Inventors: Zhongcong Xu, Culver City, CA (US); Jianfeng Zhang, Culver City, CA (US); Jun Hao Liew, Culver City, CA (US); Jiashi Feng, Culver City, CA (US)

(21) Appl. No.: 18/941,402

(22) Filed: Nov. 8, 2024

(30) Foreign Application Priority Data
Nov. 10, 2023 (CN) 202311503038.6

(51) Int. Cl. G06T 17/20; G06T 3/4053; G06V 10/44; G06V 10/82

(52) U.S. Cl. CPC G06T 17/20; G06T 3/4053; G06V 10/44; G06V 10/82

(57) ABSTRACT

Embodiments of the present disclosure disclose an image generation method, an apparatus, an electronic device, and a storage medium. The method includes: determining three-dimensional representations of preset areas in a target object according to a noise vector, wherein the three-dimensional representations are used to represent features of points in a space, and the preset areas have different size percentages in the target object; determining a three-dimensional mesh model in a target posture according to posture control parameters of the preset areas; sampling corresponding areas in the three-dimensional mesh model respectively according to camera poses for the preset areas, to obtain sampling points corresponding to the preset areas; determining target features corresponding to the sampling points according to the three-dimensional representations of the preset areas; and rendering the preset areas according to the target features, to generate target images, wherein the target images contain the target object in the target posture.

### CROSS-REFERENCE TO RELATED APPLICATION(S)

This application claims priority to Chinese Application No. 202311503038.6 filed in Nov. 10, 2023, the disclosures of which are incorporated herein by reference in their entireties.

### FIELD

Embodiments of the present disclosure relate to the field of computer technologies, and in particular, to an image generation method, an apparatus, an electronic device, and a storage medium.

### SUMMARY

Embodiments of the present disclosure provide an image generation method, an apparatus, an electronic device, and a storage medium, so that high-fidelity image generation can be achieved, and simultaneous posture control of subject and local areas can also be achieved.

According to a first aspect, an embodiment of the present disclosure provides an image generation method. The method includes:
determining three-dimensional representations of preset areas in a target object according to a noise vector, wherein the three-dimensional representations are used to represent features of points in a space, and the preset areas have different size percentages in the target object;
determining a three-dimensional mesh model in a target posture according to posture control parameters of the preset areas;
sampling corresponding areas in the three-dimensional mesh model respectively according to camera poses for the preset areas, to obtain sampling points corresponding to the preset areas;
determining target features corresponding to the sampling points according to the three-dimensional representations of the preset areas; and
rendering the preset areas according to the target features, to generate target images, wherein the target images contain the target object in the target posture.

According to a second aspect, an embodiment of the present disclosure further provides an image generation apparatus. The apparatus includes:
a three-dimensional representation determination module configured to determine three-dimensional representations of preset areas in a target object according to a noise vector, wherein the three-dimensional representations are used to represent features of points in a space, and the preset areas have different size percentages in the target object;
a mesh model determination module configured to determine a three-dimensional mesh model in a target posture according to posture control parameters of the preset areas;
a sampling module configured to sample corresponding areas in the three-dimensional mesh model respectively according to camera poses for the preset areas, to obtain sampling points corresponding to the preset areas;
a target feature determination module configured to determine target features corresponding to the sampling points according to the three-dimensional representations of the preset areas; and
an image generation module configured to render the preset areas according to the target features, to generate target images, wherein the target images contain the target object in the target posture.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the image generation method described in any one of the embodiments of the present disclosure.

According to a fourth aspect, an embodiment of the present disclosure further provides a storage medium containing computer-executable instructions that, when executed by a computer processor, are used to perform the image generation method described in any one of the embodiments of the present disclosure.

According to the technical solution of the embodiments of the present disclosure, the three-dimensional representations of the preset areas in the target object are determined according to the noise vector, wherein the three-dimensional representations are used to represent the features of the points in the space, and the preset areas have different size percentages in the target object; the three-dimensional mesh model in the target posture is determined according to the posture control parameters of the preset areas; the corresponding areas in the three-dimensional mesh model are respectively sampled according to the camera poses for the preset areas, to obtain the sampling points corresponding to the preset areas; the target features corresponding to the sampling points are determined according to the three-dimensional representations of the preset areas; and the preset areas are rendered according to the target features, to generate the target images, wherein the target images contain the target object in the target posture.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of an image generation method according to an embodiment of the present disclosure;

FIG. 2 is a schematic diagram of a tri-plane feature in an image generation method according to an embodiment of the present disclosure;

FIG. 3 is a schematic block diagram of a network structure in an image generation method according to an embodiment of the present disclosure;

FIG. 4 is a schematic diagram of a structure of an image generation apparatus according to an embodiment of the present disclosure; and

FIG. 5 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that the data involved in the technical solutions (including, but not limited to, the data itself and the access to or use of the data) shall comply with the requirements of corresponding laws, regulations, and relevant provisions.

In the prior art, a three-dimensional virtual human image may be generated by a generation model. However, since local areas such as a face and hands only occupy a small area of a human body, the generation effects of these parts are often poor, which seriously affects the authenticity of the image. Moreover, it is currently impossible to control postures of these small areas locally while controlling a posture of a virtual human body.

FIG. 1 is a schematic flowchart of an image generation method according to an embodiment of the present disclosure. This embodiment of the present disclosure is applicable to a case where an image containing a virtual object is rendered, and the virtual object in the rendered image has high reality and posture control can be achieved in preset areas. The method may be performed by an image generation apparatus. The apparatus may be implemented in the form of software and/or hardware, and may be configured in an electronic device, for example, in a computer.

As shown in FIG. 1, the image generation method provided in this embodiment may include the following steps.

S110: Determine three-dimensional representations of preset areas in a target object according to a noise vector, wherein the three-dimensional representations are used to represent features of points in a space, and the preset areas have different size percentages in the target object.

In this embodiment of the present disclosure, the noise vector may include a random noise vector, for example, a random noise vector sampled based on Gaussian distribution. The target object may be considered as a three-dimensional virtual object that needs to be included in a target image to be generated, and may be pre-divided into at least two preset areas. It may be considered that the target object may be composed of the preset areas. The preset areas have different size percentages in the target object. It may be considered that the preset areas may include a subject area with a larger size percentage in the target object, and may further include a local area with a smaller size percentage in the target object.

The three-dimensional representations are used to represent features of points in a space. It may be considered that features of spatial points in the target object may be stored in the three-dimensional representations. Any feature representation that can store a feature of a spatial point may be used as a three-dimensional representation, which is not specifically limited herein.

Since the preset areas have different size percentages in the target object, sizes of the three-dimensional representations used to store their features may also be different. When a preset area has a large size percentage in the target object, a larger three-dimensional representation may be set accordingly, and the sizes of the three-dimensional representations of the preset areas may be set by experience or experiment.

Based on an existing feature determination manner, three-dimensional representations of the preset areas in the target object may be generated according to the noise vector. For example, a constructed neural network may be used to generate the three-dimensional representations of the preset areas of the target object based on the random noise vector.

The three-dimensional representations of different sizes of the preset areas are determined, so that the preset areas can be rendered based on the corresponding three-dimensional representations, which is beneficial to improving the generation capability of preset areas with smaller size percentages, improving the image quality of the rendered image, and achieving high-fidelity image generation.

S120: Determine a three-dimensional mesh model in a target posture according to posture control parameters of the preset areas.

In this embodiment of the present disclosure, the posture control parameters may include parameters such as position and rotation, which may be used to control a posture of a corresponding preset area. The posture control parameters of the preset areas may be preset. Moreover, it is necessary to ensure that the posture control parameters are reasonable, so that postures of the preset areas are natural and reasonable. The three-dimensional mesh model may be considered as an unmapped model for reference. The three-dimensional mesh model being in the target posture means that areas in the three-dimensional mesh model that correspond to the preset areas are in postures corresponding to the posture control parameters of the preset areas, respectively.

The three-dimensional mesh model may be generated based on an existing neural network model conditioned on the posture control parameters. For example, a skinned multi-person linear expressive (SMPL-X) model may be used to deform a pre-configured standard model according to the posture control parameters of the preset areas, to generate the three-dimensional mesh model in the target posture.

S130: Sample corresponding areas in the three-dimensional mesh model respectively according to camera poses for the preset areas, to obtain sampling points corresponding to the preset areas.

In this embodiment of the present disclosure, the camera pose may include extrinsic parameters of the camera (such as rotation, translation, and other parameters). Moreover, the camera poses for the preset areas may be preset, and reasonableness is required among different camera poses. For example, a viewing angle of a camera for a higher preset area in the target object is usually an upper viewing angle, a viewing angle of a camera for a lower preset area in the target object is usually a lower viewing angle, and so on.

First, according to the camera poses for the preset areas, a plurality of light rays for sampling the three-dimensional mesh model may be emitted from viewpoints of the cameras. Further, points closest to the light rays may be determined from areas in the three-dimensional mesh model that correspond to the preset areas, and these points may be referred to as sampling points corresponding to the preset areas.

S140: Determine target features corresponding to the sampling points according to the three-dimensional representations of the preset areas.

Based on an inverse linear blend skinning (IS) method, corresponding spatial points in the three-dimensional representations may be determined according to spatial positions of the sampling points in the three-dimensional mesh model. Features of the spatial points are used as the target features corresponding to the sampling points, so as to perform a subsequent image rendering step according to the target features.

Determining the corresponding spatial points in the three-dimensional representations according to the spatial positions of the sampling points in the three-dimensional mesh model may include: reversely mapping the sampling points to the standard model according to an amount of deforming the standard model to the three-dimensional mesh model, and the spatial positions of the sampling points in the three-dimensional mesh model, to obtain standard sampling points; and determining spatial points in the three-dimensional representations that correspond to the standard sampling points according to a spatial correspondence between the standard model and the three-dimensional representations, wherein the spatial points may be considered as spatial points corresponding to the sampling points.

The target features corresponding to the sampling points of the preset areas are determined according to the camera poses for the preset areas respectively, so that the quality of image generation of the preset areas may be further improved.

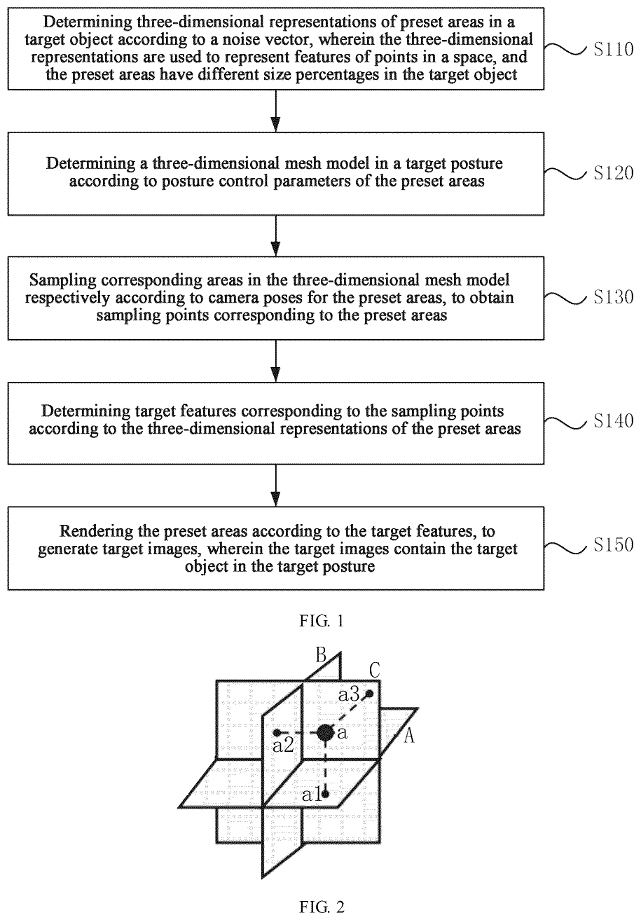

In some optional implementations, the three-dimensional representation includes a tri-plane feature. The tri-plane feature is composed of three plane features that are orthogonal. For example, FIG. 2 is a schematic diagram of a tri-plane feature in an image generation method according to an embodiment of the present disclosure. Referring to FIG. 2, the tri-plane feature includes feature maps of three planes, namely, a feature map of a plane A, a feature map of a plane B, and a feature map of a plane C, and the plane A, the plane B, and the plane C are orthogonal to each other. There is a spatial correspondence between a three-dimensional space formed by the tri-plane feature and the standard model that has not yet been deformed to the three-dimensional mesh model.

Correspondingly, determining the target features corresponding to the sampling points according to the three-dimensional representations of the preset areas may include: mapping the sampling points into corresponding tri-plane features according to the posture control parameters of the preset areas, to obtain mapping points; and determining the target features according to feature components of the plane features in the tri-plane features to which the mapping points belong.

The amount of deforming the standard model to the three-dimensional mesh model may be determined according to the posture control parameters of the preset areas. Further, the sampling points may be reversely mapped to the standard model according to the deformation amount and the spatial positions of the sampling points in the three-dimensional mesh model, to obtain the standard sampling points. The spatial points in the tri-plane feature that correspond to the standard sampling points are determined according to the spatial correspondence between the standard model and the tri-plane feature, that is, the mapping points are obtained.

Since different mapping points correspond to different preset areas, a tri-plane feature of a preset area corresponding to a mapping point may be used as the tri-plane feature to which the mapping point belongs. After the mapping points are determined, taking a mapping point a in FIG. 2 as an example, a process of determining its target features may include: separately projecting the mapping point a onto the plane A, the plane B, and the plane C, to obtain projection points a1, a2, and a3; obtaining features at a1, a2, and a3 as feature components of the mapping point; and determining the target feature according to the feature components, for example, performing weighted summation on the feature components to obtain the target feature.

In these optional implementations, the three-dimensional representation may be a tri-plane feature. Further, the target features may be determined according to the feature components of the mapping points corresponding to the sampling points on the tri-plane features.

S150: Render the preset areas according to the target features, to generate target images, wherein the target images contain the target object in the target posture.

After the target features corresponding to the sampling points are determined, colors and geometric structures of the preset areas may be rendered based on the target features in an existing rendering manner. For example, a network layer composed of a multilayer perceptron (MLP) may be used to encode the target features as colors and geometric shapes. Geometric modeling may be performed by using a signed distance field (SDF).

In addition, during the process of rendering the preset areas, an area connecting at least two preset areas may be rendered according to target features of sampling points of the area in the three-dimensional representations corresponding to the at least two preset areas. For example, weighted summation may be performed on the target features of the sampling points of the area in the three-dimensional representations corresponding to the at least two preset areas, to obtain final target features of the sampling points in the area, for rendering the area. Based on this rendering manner, a smooth transition of the connecting area may be achieved, and the image quality may be improved.

In some optional implementations, rendering the preset areas according to the target features, to generate the target images may include: rendering the preset areas according to the target features, to obtain initial images; and performing super-resolution reconstruction on the initial images, to obtain the target images. The super-resolution reconstruction on the rendered initial images may be performed based on an existing super-resolution reconstruction network, which can improve the image definition and further improve the quality of image generation.

According to the technical solution of the embodiments of the present disclosure, the three-dimensional representations of the preset areas in the target object are determined according to the noise vector, wherein the three-dimensional representations are used to represent the features of the points in the space, and the preset areas have different size percentages in the target object; the three-dimensional mesh model in the target posture is determined according to the posture control parameters of the preset areas; the corresponding areas in the three-dimensional mesh model are respectively sampled according to the camera poses for the preset areas, to obtain the sampling points corresponding to the preset areas; the target features corresponding to the sampling points are determined according to the three-dimensional representations of the preset areas; and the preset areas are rendered according to the target features, to generate the target images, wherein the target images contain the target object in the target posture.

In the technical solution of the embodiments of the present disclosure, corresponding three-dimensional representations may be determined for the preset areas with different size percentages in the target object respectively, so that the preset areas may be rendered based on the three-dimensional representations, thereby ensuring high-fidelity image generation for the preset areas with different size percentages in the target object. In addition, the three-dimensional mesh model may be generated according to the posture control parameters of the preset areas. On this basis, sampling may be performed, and the target features corresponding to the sampling points may be obtained for rendering the preset areas, which can achieve posture control of the preset areas with different size percentages in the target object.

This embodiment of the present disclosure may be combined with various optional solutions in the image generation method provided in the above embodiments. The image generation method provided in this embodiment describes in detail a network structure corresponding to the image generation method. A generator network may be used to generate the three-dimensional representations according to the noise vector. A neural rendering network may be used to obtain the target features corresponding to the sampling points, and render the preset areas according to the target features. Moreover, the generator network and the neural rendering network may be constructed by performing generative adversarial training with discriminator networks, thereby ensuring the authenticity of the rendered images.

In the image generation method provided in this embodiment, determining the three-dimensional representations of the preset areas in the target object according to the noise vector includes: determining, by the generator network, the three-dimensional representations of the preset areas in the target object according to the noise vector; and rendering the preset areas according to the target features includes: rendering, by the neural rendering network, the preset areas according to the target features, wherein the generator network and the neural rendering network are constructed by performing generative adversarial training with the discriminator networks for the preset areas.

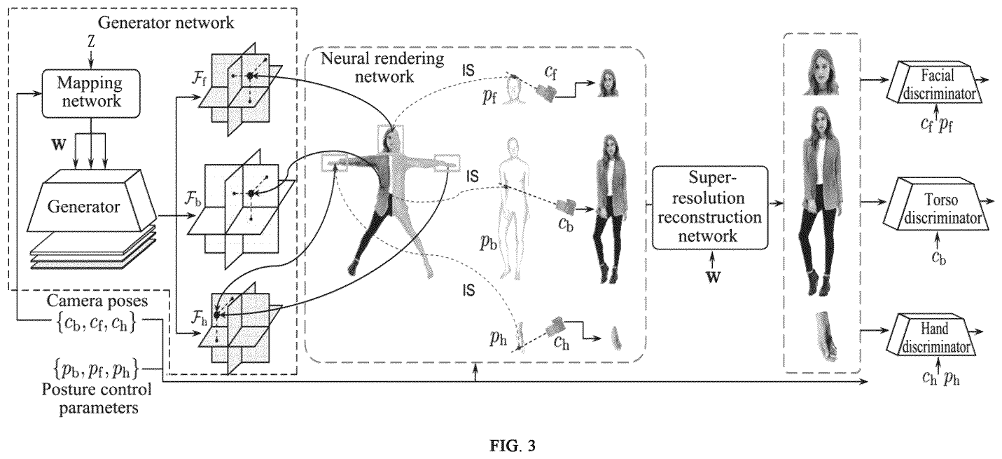

For example, FIG. 3 is a schematic block diagram of a network structure in an image generation method according to an embodiment of the present disclosure. As shown in FIG. 3, the target object may include a virtual human body object. Correspondingly, the preset areas may include a torso area, a facial area, and a hand area. In this embodiment of the present disclosure, a process of image generation and a process of network construction are described by taking the target object and the preset areas shown in FIG. 3 as an example. In the case of other target objects and/or preset areas, reference may be made to the corresponding explanations in this embodiment of the present disclosure, which are not exhausted herein.

Referring to FIG. 3, a process of generating target images containing a virtual human body object may include the following steps.

Steps performed by the generator network are:
receiving the noise vector Z and a control parameter c_{b} of the torso area; encoding Z and c_{b} through a mapping network in the generator network, to obtain three identical encoding results W; and synthesizing, through a generator in the generator network, a three-dimensional representation F_{b} of the torso area, a three-dimensional representation F_{f} of the facial area, and a three-dimensional representation Fₕ of the hand area respectively, according to the input W.

During the process of network construction, using the control parameter c_{b} of the torso area as a generation condition for a three-dimensional representation can ensure that rendering results output by the network have good stability. Moreover, during the process of construction, a weight of c_{b} input into the generator network may be gradually decreased to gradually optimize network parameters. Correspondingly, when generating images based on the constructed network, c_{b} may also be input into the generator network for the generation of the three-dimensional representations.

In order to balance the rendering accuracy of the facial area and the hand area as well as the amount of network computation, the sizes of the tri-plane features of the facial area and the hand area may be set to half of the tri-plane feature of the torso area. In addition, to further save computational costs, the symmetry of the hands may be utilized, so that one tri-plane feature may be used to represent the left and right hands through a horizontal flip operation.

Steps performed by the neural rendering network are:
determining a three-dimensional mesh model in a target posture according to a posture control parameter p_{b} of the torso area, a posture control parameter p_{f} of the facial area, and a posture control parameter pₕ of the hand area; sampling, according to a camera pose c_{b} for the torso area, a camera pose c_{f} for the facial area, and a camera pose cₕ for the hand area, corresponding areas in the three-dimensional mesh model respectively, to obtain sampling points corresponding to the preset areas; determining, based on the inverse linear blend skinning (represented by IS pₕ in FIG. 3) method, corresponding mapping points in the three-dimensional representations according to spatial positions of the sampling points in the three-dimensional mesh model; determining target features according to feature components of the plane features in the tri-plane features to which the mapping points belong; and rendering the corresponding torso area, facial area or hand area according to the target features, to generate initial images, wherein the initial images contain the virtual human body object in the target posture.

Bounding boxes for the facial area, a left hand area, and a right hand area may be defined in the standard model that has not yet been deformed to the three-dimensional mesh model. After the sampling points are mapped to the standard model, if they fall into these defined bounding boxes, the mapping points and the target features may be determined from tri-plane features corresponding to the bounding boxes.

In addition, the super-resolution reconstruction network may be used to perform the super-resolution reconstruction on the initial image, to obtain target images with high definition.

Referring to FIG. 3, during the process of constructing the generator network and the neural rendering network, they may be further connected to a facial discriminator, a torso discriminator and a hand discriminator behind the super-resolution reconstruction network, so that the generator network and the neural rendering network may perform generative adversarial training with the discriminator networks. By supervising generation results of the areas through the discriminator networks, the quality of image generation and control capability may be ensured. After the network construction is completed, the discriminator networks may be removed from the overall network structure, to output the target images.

In an existing solution for generating images containing a three-dimensional virtual human body object, controllable areas in the generated image are limited to the torso area, while the facial area and the hand area cannot be controlled. In addition, since the facial area, the hand area, and other areas only occupy a small area of a human body, the authenticity of generated details are often poor.

The method of generating images containing a virtual human body object provided in the present disclosure can render the torso area, the facial area and the hand area respectively through multi-part and multi-scale three-dimensional representations, which can improve the image generation capability of the facial area and the hand area. In addition, by performing multi-part rendering based on a plurality of posture control parameters and camera poses, the torso area, the facial area and the hand area can be controlled simultaneously, and the image quality of the hand area and the facial area can also be improved. It is proved by experiments that the image generation method provided in the present disclosure has excellent image generation effects and control capability for virtual portrait objects on public datasets.

In some optional implementations, a process of constructing the generator network and the neural rendering network may include:
performing rendering by the generator network and the neural rendering network according to a sample noise vector, sample camera poses for the preset areas, and sample posture control parameters of the preset areas, to obtain images of the preset areas; performing, by the discriminator networks for the preset areas, discrimination on the images of the preset areas respectively, to obtain discrimination results; and determining a generative adversarial loss according to the discrimination results, and constructing the generator network, the neural rendering network, and the discriminator networks based on the generative adversarial loss.

With reference to the process of generating the target images containing the virtual human body object in this embodiment of the present disclosure, rendering may be performed according to a sample noise vector, sample camera poses for the preset areas, and sample posture control parameters of the preset areas, to obtain images of the preset areas.

Referring again to FIG. 3, when the target object is a virtual human body object, and the preset areas include a torso area, a facial area, and a hand area, the discriminator networks may include a facial discriminator, a torso discriminator and a hand discriminator. The rendered target images may be used as an input to the torso discriminator, the facial area in the target images may be used as an input to the facial discriminator, and the hand area in the target images may be used as an input to the hand discriminator. In some implementations, the posture control parameter p_{b} and the camera pose c_{b} for the torso area may be used as inputs to the torso discriminator simultaneously, the posture control parameter p_{f} and the camera pose c_{f} for the facial area may be used as inputs to the facial discriminator simultaneously, and the posture control parameter pₕ and the camera pose cₕ for the hand area may be used as inputs to the hand discriminator simultaneously, thereby improving the accuracy of the discriminators.

Discrimination is performed on the images of the preset areas by the discriminator networks for the preset areas respectively, to obtain a score indicating that the images are real, which is used to determine the generative adversarial loss. Afterwards, the generator network, the neural rendering network, and the discriminator networks may be constructed based on the generative adversarial loss.

For example, the generative adversarial loss may be determined based on the following formula:

$${L}_{G} = {L}_{b}^{G} + {λ}_{f} {M}_{f} ⊙ {L}_{f}^{G} + {λ}_{h} {M}_{h} ⊙ {L}_{h}^{G} ;$$

$${L}_{D} = {L}_{b}^{D} + {L}_{R 1}^{b} + {λ}_{f} {M}_{f} ⊙ ( {L}_{f}^{D} + {L}_{R 1}^{f} ) + {λ}_{h} {M}_{h} ⊙ ( {L}_{h}^{D} + {L}_{R 1}^{h} ) ;$$

where, L_{G} may represent an image generation loss of the generator network and the neural rendering network, which may be used to adjust the network parameters of the generator network and the neural rendering network to make the generated images closer to real images; L_{D} may represent a discriminant loss of the discriminator networks, which may be used to adjust the network parameters of the discriminator networks, so that the discriminator networks may accurately identify that output images of the generator network and the neural rendering network are fake;
where, L_{b}^{⋅}, L_{f}^{⋅}, and Lₕ^{⋅} may respectively represent generation or discrimination losses of the torso area, the facial area and the hand area, and when the upper right corner is G, it means the image generation loss, and when the upper right corner is D, it means the discrimination loss; λ_{b}, λ_{f}, and λₕ may respectively represent loss weighting factors of the torso area, the facial area and the hand area, and may be obtained through learning; M_{f} and Mₕ may be set to zero when the facial area and the hand area are not visible in the target images, to balance the image generation loss; L_{R1}^{b}, L_{R1}^{f}, and L_{R1}^{h} may respectively represent regularization losses of the torso area, the facial area and the hand area, to regularize the discriminator ⊙ networks; may represent an instance multiplication.

In addition, in some implementations, in order to improve the reasonableness and smoothness of the preset areas in the geometric dimension, a minimum surface loss L_{min sorf}, an optical path function loss (Eikonal loss) L_{Eik}, and a prior regularization loss Lₚᵣᵢₒᵣ, etc., may further be added to the L_{G}.

In these optional implementations, the rendering results of the areas are supervised by setting up discriminator networks corresponding to multi-part areas, which can ensure the quality of image generation and the control capability of the areas.

The technical solution of this embodiment of the present disclosure describes in detail a network structure corresponding to the image generation method. A generator network may be used to generate the three-dimensional representations according to the noise vector. A neural rendering network may be used to obtain the target features corresponding to the sampling points, and render the preset areas according to the target features. Moreover, the generator network and the neural rendering network may be constructed by performing generative adversarial training with discriminator networks, thereby ensuring the authenticity of the rendered images. Furthermore, the image generation method provided in this embodiment of the present disclosure and the image generation method provided in the above embodiments belong to the same concept of disclosure. For the technical details not described in detail in this embodiment, reference may be made to the above embodiments, and the same technical features have the same beneficial effects in this embodiment and the above embodiments.

This embodiment of the present disclosure may be combined with various optional solutions in the image generation method provided in the above embodiments. The image generation method provided in this embodiment describes in detail actual downstream application scenarios, such as text-driven generation of the target object, or speech-driven posture of the target object, etc.

The image generation method provided in this embodiment may further include: generating the noise vector according to a text description for the target object. The text description for the target object may be converted into the noise vector based on an existing text-to-vector method. The text description may be obtained by recognizing speech data, or may be text data directly input by a user. By generating the noise vector based on the text description, the generated target object may be made to fit the text description to meet image generation needs of the user.

The image generation method provided in this embodiment may further include: obtaining a sequence of posture control parameters of the preset areas. Correspondingly, after rendering is performed to obtain target images corresponding to posture control parameters in the sequence of posture control parameters, the method further includes: generating a target video according to the target images.

Current posture control parameters of the preset areas may be obtained in sequence from the sequence of posture control parameters of the preset areas, and the three-dimensional mesh model may be generated according to the current posture control parameters. Then, the corresponding areas in the three-dimensional mesh model are respectively sampled according to the camera poses for the preset areas, to obtain the sampling points corresponding to the preset areas. The target features corresponding to the sampling points are determined according to the three-dimensional representations of the preset areas. The preset areas are rendered according to the target features, to generate the target images. After a sequence of the target images is obtained, based on an existing method of generating a video from images, the target video may further be generated according to the target images, so as to dynamically control the postures of the preset areas of the target object to meet animation generation needs of the user.

In some implementations, obtaining the sequence of posture control parameters of the preset areas may include: determining the sequence of posture control parameters of the preset areas according to received speech data. The sequence of posture control parameters of the preset areas may be determined from the received speech data based on an existing natural language processing model. For example, when the speech data is “Raise your right hand quickly and then slowly put it down”, a series of posture control parameters of the right hand area may be set to achieve the action effect described by the speech data. Thus, driving the posture of the target object by speech may be achieved, reducing a threshold of animation generation and improving the user experience.

This technical solution of the embodiment of the present disclosure describes in detail the actual downstream application scenarios, such as text-driven generation of the target object, or speech-driven pose of the target object, etc. The image generation method provided in this embodiment of the present disclosure and the image generation method provided in the above embodiments belong to the same concept of disclosure. For the technical details not described in detail in this embodiment, reference may be made to the above embodiments, and the same technical features have the same beneficial effects in this embodiment and the above embodiments.

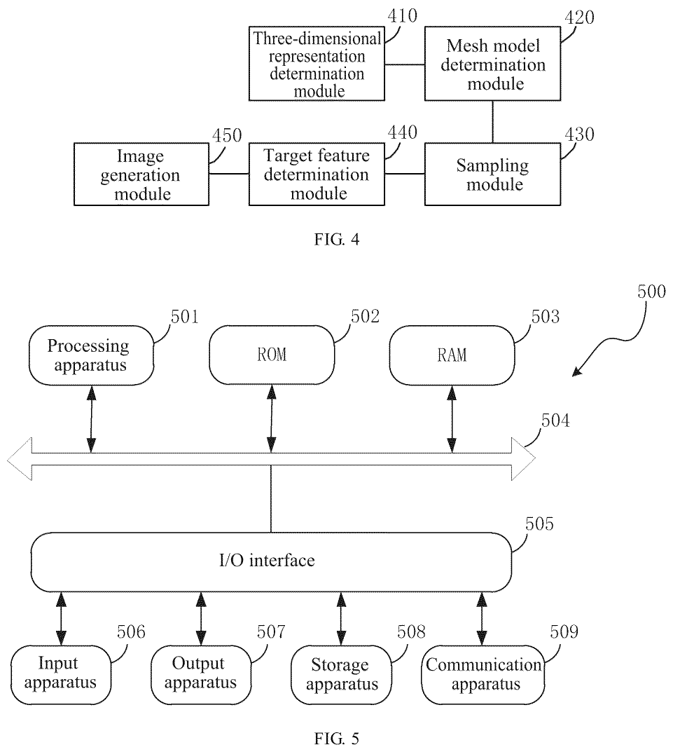

FIG. 4 is a schematic diagram of a structure of an image generation apparatus according to an embodiment of the present disclosure. The image generation apparatus provided in this embodiment is applicable to a case where an image containing a virtual object is rendered, and the virtual object in the rendered image has high reality and posture control can be achieved in preset areas.

As shown in FIG. 4, the image generation apparatus provided in this embodiment of the present disclosure may include:
a three-dimensional representation determination module 410 configured to determine three-dimensional representations of preset areas in a target object according to a noise vector, wherein the three-dimensional representations are used to represent features of points in a space, and the preset areas have different size percentages in the target object;
a mesh model determination module 420 configured to determine a three-dimensional mesh model in a target posture according to posture control parameters of the preset areas;
a sampling module 430 configured to sample, corresponding areas in the three-dimensional mesh model respectively according to camera poses for the preset areas, to obtain sampling points corresponding to the preset areas;
a target feature determination module 440 configured to determine target features corresponding to the sampling points according to the three-dimensional representations of the preset areas; and
an image generation module 450 configured to render the preset areas according to the target features, to generate target images, wherein the target images contain the target object in the target posture.

In some optional implementations, the three-dimensional representation includes a tri-plane feature. The tri-plane feature is composed of three plane features that are orthogonal.

Correspondingly, the target feature determination module may be configured to:
map the sampling points into corresponding tri-plane features according to the posture control parameters of the preset areas, to obtain mapping points; and
determine target features according to feature components of the plane features in the tri-plane features to which the mapping points belong.

In some optional implementations, the three-dimensional representation determination module may be configured to: determine, by the generator network, the three-dimensional representations of the preset areas in the target object according to the noise vector; and the image generation module may be configured to: render, by the neural rendering network, the preset areas according to the target features, wherein the generator network and the neural rendering network are constructed by performing generative adversarial training with discriminator networks for the preset areas.

In some optional implementations, the image generation apparatus may further include: a construction module that may be configured to construct the generator network and the neural rendering network based on the following process:
performing rendering by the generator network and the neural rendering network according to a sample noise vector, sample camera poses for the preset areas, and sample posture control parameters of the preset areas, to obtain images of the preset areas;
performing, by the discriminator networks for the preset areas, discrimination on the images of the preset areas respectively, to obtain discrimination results; and
determining a generative adversarial loss according to the discrimination results, and constructing the generator network, the neural rendering network, and the discriminator networks based on the generative adversarial loss.

In some optional implementations, the image generation module may further be configured to:
render the preset areas according to the target features, to obtain initial images; and
perform super-resolution reconstruction on the initial images, to obtain target images.

In some optional implementations, the image generation apparatus may further include: a noise generation module configured to generate the noise vector according to a text description for the target object.

In some optional implementations, the image generation apparatus may further include:
a parameter sequence obtaining module configured to obtain a sequence of posture control parameters of the preset areas.

Correspondingly, the image generation module may further be configured to generate a target video according to the target images after rendering is performed to obtain target images corresponding to posture control parameters in the sequence of posture control parameters.

In some optional implementations, the parameter sequence obtaining module may be configured to:
determine the sequence of posture control parameters of the preset areas according to received speech data.

In some optional implementations, the target object includes a virtual human body object. Correspondingly, the preset areas include a torso area, a facial area, and a hand area.

The image generation apparatus provided in this embodiment of the present disclosure can perform the image generation method provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

Reference is made to FIG. 5 below, which is a schematic diagram of a structure of an electronic device (such as a terminal device or a server in FIG. 5) 500 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 500 may include a processing apparatus (e.g., a central processor, a graphics processor, etc.) 501 that may perform a variety of appropriate actions and processing in accordance with a program stored in a read-only memory (ROM) 502 or a program loaded from a storage apparatus 508 into a random-access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, wherein the computer program includes program code for performing the method shown in the flowchart. In such an embodiment, the computer program may be downloaded and installed from a network through the communication apparatus 509, installed from the storage apparatus 508, or installed from the ROM 502. When the computer program is executed by the processing apparatus 501, the above-mentioned functions defined in the image generation method of the embodiment of the present disclosure are performed.

The electronic device provided in this embodiment of the present disclosure and the image generation methods provided in the above embodiments belong to the same concept of disclosure. For the technical details not described in detail in this embodiment, reference may be made to the above embodiments, and this embodiment and the above embodiments have the same beneficial effects.

This embodiment of the present disclosure provides a computer storage medium having stored thereon a computer program that, when executed by a processor, causes the image generation methods provided in the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electric connection with one or more wires, a portable computer disk, a hard disk, a random access memory (RAM), a read only memory (ROM), an erasable programmable read-only memory (EPROM) or a flash memory (FLASH), an optical fiber, a portable compact disc read only memory (CD-ROM), an optical storage device, a magnetic storage device, or any appropriate combination of the above. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
determine three-dimensional representations of preset areas in a target object according to a noise vector, wherein the three-dimensional representations are used to represent features of points in a space, and the preset areas have different size percentages in the target object; determine a three-dimensional mesh model in a target posture according to posture control parameters of the preset areas; sample corresponding areas in the three-dimensional mesh model respectively according to camera poses for the preset areas, to obtain sampling points corresponding to the preset areas; determine target features corresponding to the sampling points according to the three-dimensional representations of the preset areas; and render the preset areas according to the target features, to generate the target images, wherein the target images contain the target object in the target posture.

Computer program code for performing operations of the present disclosure can be written in one or more programming languages or a combination thereof, wherein the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The names of the units and the modules do not constitute a limitation on the units and the modules themselves under certain circumstances.

The functions described herein above may be performed at least partially by one or more hardware logic components. For example, without limitation, exemplary types of hardware logic components that may be used include: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, an image generation method is provided. The method includes:
determining three-dimensional representations of preset areas in a target object according to a noise vector, wherein the three-dimensional representations are used to represent features of points in a space, and the preset areas have different size percentages in the target object; determining a three-dimensional mesh model in a target posture according to posture control parameters of the preset areas;
sampling corresponding areas in the three-dimensional mesh model respectively according to camera poses for the preset areas, to obtain sampling points corresponding to the preset areas;
determining target features corresponding to the sampling points according to the three-dimensional representations of the preset areas; and
rendering the preset areas according to the target features, to generate target images, wherein the target images contain the target object in the target posture.

According to one or more embodiments of the present disclosure, the image generation method is provided. The method further includes the following.

In some optional implementations, the three-dimensional representation includes a tri-plane feature, wherein the tri-plane feature is composed of three plane features that are orthogonal; and

Correspondingly, determining the target features corresponding to the sampling points according to the three-dimensional representations of the preset areas includes:
mapping the sampling points into corresponding tri-plane features according to the posture control parameters of the preset areas, to obtain mapping points; and
determining the target features according to feature components of the plane features in the tri-plane features to which the mapping points belong.

According to one or more embodiments of the present disclosure, the image generation method is provided. The method further includes the following.

In some optional implementations, determining the three-dimensional representations of the preset areas in the target object according to the noise vector includes: determining, by a generator network, the three-dimensional representations of the preset areas in the target object according to the noise vector; and
rendering the preset areas according to the target features includes: rendering, by a neural rendering network, the preset areas according to the target features, wherein the generator network and the neural rendering network are constructed by performing generative adversarial training with discriminator networks for the preset areas.

According to one or more embodiments of the present disclosure, the image generation method is provided. The method further includes the following.

In some optional implementations, a process of constructing the generator network and the neural rendering network includes:
performing rendering by the generator network and the neural rendering network according to a sample noise vector, sample camera poses for the preset areas, and sample posture control parameters of the preset areas, to obtain images of the preset areas;
performing, by the discriminator networks for the preset areas, discrimination on the images of the preset areas respectively, to obtain discrimination results; and
determining a generative adversarial loss according to the discrimination results, and constructing the generator network, the neural rendering network, and the discriminator networks based on the generative adversarial loss.

According to one or more embodiments of the present disclosure, the image generation method is provided. The method further includes the following.

In some optional implementations, rendering the preset areas according to the target features, to generate the target images includes:
rendering the preset areas according to the target features, to obtain initial images; and
performing super-resolution reconstruction on the initial images, to obtain the target images.

According to one or more embodiments of the present disclosure, the image generation method is provided. The method further includes the following.

In some optional implementations, the noise vector is generated according to a text description for the target object.

According to one or more embodiments of the present disclosure, the image generation method is provided. The method further includes the following.

In some optional implementations, a sequence of posture control parameters of the preset areas is obtained.

Correspondingly, after rendering is performed to obtain target images corresponding to posture control parameters in the sequence of posture control parameters, the method further includes: generating a target video according to the target images.

According to one or more embodiments of the present disclosure, the image generation method is provided. The method further includes the following.

In some optional implementations, obtaining the sequence of posture control parameters of the preset areas includes:
determining the sequence of posture control parameters of the preset areas according to received speech data.

According to one or more embodiments of the present disclosure, the image generation method is provided. The method further includes the following.

In some optional implementations, the target object includes a virtual human body object. Correspondingly, the preset areas include a torso area, a facial area, and a hand area.

According to one or more embodiments of the present disclosure, an image generation apparatus is provided. The apparatus includes:
a three-dimensional representation determination module configured to determine three-dimensional representations of preset areas in a target object according to a noise vector, wherein the three-dimensional representations are used to represent features of points in a space, and the preset areas have different size percentages in the target object;
a mesh model determination module configured to determine a three-dimensional mesh model in a target posture according to posture control parameters of the preset areas;
a sampling module configured to sample corresponding areas in the three-dimensional mesh model respectively according to camera poses for the preset areas, to obtain sampling points corresponding to the preset areas;
a target feature determination module configured to determine target features corresponding to the sampling points according to the three-dimensional representations of the preset areas; and
an image generation module configured to render the preset areas according to the target features, to generate target images, wherein the target images contain the target object in the target posture.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. An image generation method, comprising:
determining three-dimensional representations of preset areas in a target object according to a noise vector, wherein the three-dimensional representations are used to represent features of points in a space, and the preset areas have different size percentages in the target object;
determining a three-dimensional mesh model in a target posture according to posture control parameters of the preset areas;
sampling corresponding areas in the three-dimensional mesh model respectively according to camera poses for the preset areas, to obtain sampling points corresponding to the preset areas;
determining target features corresponding to the sampling points according to the three-dimensional representations of the preset areas; and
rendering the preset areas according to the target features, to generate target images, wherein the target images contain the target object in the target posture.

2. The method according to claim 1, wherein the three-dimensional representation comprises a tri-plane feature, wherein the tri-plane feature is composed of three plane features that are orthogonal; and
correspondingly, determining the target features corresponding to the sampling points according to the three-dimensional representations of the preset areas comprises:
mapping the sampling points into corresponding tri-plane features according to the posture control parameters of the preset areas, to obtain mapping points; and
determining the target features according to feature components of the plane features in the tri-plane features to which the mapping points belong.

3. The method according to claim 1, wherein determining the three-dimensional representations of the preset areas in the target object according to the noise vector comprises:
determining, by a generator network, the three-dimensional representations of the preset areas in the target object according to the noise vector; and
rendering the preset areas according to the target features comprises: rendering, by a neural rendering network, the preset areas according to the target features,
wherein the generator network and the neural rendering network are constructed by performing generative adversarial training with discriminator networks for the preset areas.

4. The method according to claim 3, wherein a process of constructing the generator network and the neural rendering network comprises:
performing rendering by the generator network and the neural rendering network according to a sample noise vector, sample camera poses for the preset areas, and sample posture control parameters of the preset areas, to obtain images of the preset areas;
performing, by the discriminator networks for the preset areas, discrimination on the images of the preset areas respectively, to obtain discrimination results; and
determining a generative adversarial loss according to the discrimination results, and constructing the generator network, the neural rendering network, and the discriminator networks based on the generative adversarial loss.

5. The method according to claim 1, wherein rendering the preset areas according to the target features, to generate the target images comprises:
rendering the preset areas according to the target features, to obtain initial images; and
performing super-resolution reconstruction on the initial images, to obtain the target images.

6. The method according to claim 1, wherein the method further comprises:
generating the noise vector according to a text description for the target object.

7. The method according to claim 1, wherein the method further comprises:
obtaining a sequence of posture control parameters of the preset areas; and
correspondingly, the method further comprises: after rendering is performed to obtain target images corresponding to posture control parameters in the sequence of posture control parameters, generating a target video according to the target images.

8. The method according to claim 7, wherein obtaining the sequence of posture control parameters of the preset areas comprises:
determining the sequence of posture control parameters of the preset areas according to received speech data.

9. The method according to claim 1, wherein the target object comprises a virtual human body object; and correspondingly, the preset areas comprise a torso area, a facial area, and a hand area.

10. An electronic device, comprising:
one or more processors; and
a storage apparatus configured to store one or more programs, wherein
the one or more programs, when executed by the one or more processors, cause the one or more processors to implement an image generation method comprising:
determining three-dimensional representations of preset areas in a target object according to a noise vector, wherein the three-dimensional representations are used to represent features of points in a space, and the preset areas have different size percentages in the target object;
determining a three-dimensional mesh model in a target posture according to posture control parameters of the preset areas;
sampling corresponding areas in the three-dimensional mesh model respectively according to camera poses for the preset areas, to obtain sampling points corresponding to the preset areas;
determining target features corresponding to the sampling points according to the three-dimensional representations of the preset areas; and
rendering the preset areas according to the target features, to generate target images, wherein the target images contain the target object in the target posture.

11. The electronic device according to claim 10, wherein the three-dimensional representation comprises a tri-plane feature, wherein the tri-plane feature is composed of three plane features that are orthogonal; and
correspondingly, determining the target features corresponding to the sampling points according to the three-dimensional representations of the preset areas comprises:
mapping the sampling points into corresponding tri-plane features according to the posture control parameters of the preset areas, to obtain mapping points; and
determining the target features according to feature components of the plane features in the tri-plane features to which the mapping points belong.

12. The electronic device according to claim 10, wherein determining the three-dimensional representations of the preset areas in the target object according to the noise vector comprises:
determining, by a generator network, the three-dimensional representations of the preset areas in the target object according to the noise vector; and
rendering the preset areas according to the target features comprises: rendering, by a neural rendering network, the preset areas according to the target features,
wherein the generator network and the neural rendering network are constructed by performing generative adversarial training with discriminator networks for the preset areas.

13. The electronic device according to claim 12, wherein a process of constructing the generator network and the neural rendering network comprises:
performing rendering by the generator network and the neural rendering network according to a sample noise vector, sample camera poses for the preset areas, and sample posture control parameters of the preset areas, to obtain images of the preset areas;
performing, by the discriminator networks for the preset areas, discrimination on the images of the preset areas respectively, to obtain discrimination results; and
determining a generative adversarial loss according to the discrimination results, and constructing the generator network, the neural rendering network, and the discriminator networks based on the generative adversarial loss.

14. The electronic device according to claim 10, wherein rendering the preset areas according to the target features, to generate the target images comprises:
rendering the preset areas according to the target features, to obtain initial images; and
performing super-resolution reconstruction on the initial images, to obtain the target images.

15. The electronic device according to claim 10, wherein the method further comprises:
generating the noise vector according to a text description for the target object.

16. The electronic device according to claim 10, wherein the method further comprises:
obtaining a sequence of posture control parameters of the preset areas; and
correspondingly, the method further comprises: after rendering is performed to obtain target images corresponding to posture control parameters in the sequence of posture control parameters, generating a target video according to the target images.

17. The electronic device according to claim 16, wherein obtaining the sequence of posture control parameters of the preset areas comprises:
determining the sequence of posture control parameters of the preset areas according to received speech data.

18. The electronic device according to claim 10, wherein the target object comprises a virtual human body object; and correspondingly, the preset areas comprise a torso area, a facial area, and a hand area.

19. A non-transitory storage medium containing computer-executable instructions, wherein the computer-executable instructions, when executed by a computer processor, are used to perform an image generation method comprising:
determining three-dimensional representations of preset areas in a target object according to a noise vector, wherein the three-dimensional representations are used to represent features of points in a space, and the preset areas have different size percentages in the target object;
determining a three-dimensional mesh model in a target posture according to posture control parameters of the preset areas;
sampling corresponding areas in the three-dimensional mesh model respectively according to camera poses for the preset areas, to obtain sampling points corresponding to the preset areas;
determining target features corresponding to the sampling points according to the three-dimensional representations of the preset areas; and
rendering the preset areas according to the target features, to generate target images, wherein the target images contain the target object in the target posture.

20. The non-transitory storage medium of claim 19, wherein the three-dimensional representation comprises a tri-plane feature, wherein the tri-plane feature is composed of three plane features that are orthogonal; and
correspondingly, determining the target features corresponding to the sampling points according to the three-dimensional representations of the preset areas comprises:
mapping the sampling points into corresponding tri-plane features according to the posture control parameters of the preset areas, to obtain mapping points; and
determining the target features according to feature components of the plane features in the tri-plane features to which the mapping points belong.
